(19) United States
(12) Patent Application Publication
(10) Pub. No.: US 2007/0279435 A1
(43) Pub. Date: Dec. 6, 2007

(54) Method and system for selective visualization and interaction with 3D image data

(76) Inventors: Hern Ng, Singapore (SG); Lin Chia Goh, Singapore (SG); Yapeng Wang, Singapore (SG); Luis Del Molino Serra, Singapore (SG)

Correspondence Address: GREENBERG TRAURIG, LLP (SV2), 2450 Colorado Avenue, Suite 400E, Santa Monica, CA, 90404, US

(21) Appl. No.: 11/445,818

(22) Filed: Jun. 2, 2006

(51) Int. Cl. G09G 5/00

(52) U.S. Cl. 345/624; 345/427

(57) ABSTRACT

A data processing system which allows a user to interactively identify a portion of a volume and display the identified portion of the volume in a way that is particularly adapted for the visualization of the identified portion of the volume. One embodiment provides identifying a location of a volume based on input communicated via an input interface having at least 3 degrees of spatial freedom for input control; and displaying the volume and separately displaying a portion of the volume corresponding to the location. In one embodiment, the input interface includes a hand held device; and the displaying further comprises displaying a virtual tool corresponding to a location of the hand held device. For example, a slice of a volume can be selected and displayed in an orientation that maximizes a displayed size and is consistent with the orientation of the slice in a 3D view of the volume.

### TECHNOLOGY FIELD

At least some embodiments of the disclosure relate to imaging techniques, and more particularly but not exclusively, to the visualization of and interaction with 3D image data, such as 3D images obtained using medical imaging techniques.

### BACKGROUND

Many medical imaging techniques, such as, Magnetic Resonance Imaging (MRI), Magnetic Resonance Angiography (MRA), Computed Tomography (CT) and Ultrasonography (US), are available to collect internal images of a patient without having to make a single incision to the patient. Such imaging techniques can be used to obtain three-dimensional (3D) image data sets that provide information about various points in a 3D volume corresponding to bodies or body parts of the patient. Such 3D image data sets can be visualized and manipulated in a data processing system for diagnostics, surgical planning, and therapeutic operations.

For example, a MRI scan and/or a CT scan of a patient's head can be used in a computer to generate a 3D virtual model of the head. The 3D virtual model of the head can be displayed for visualization and for interactive manipulations on a computer system. In response to user input, the computer system may rotate the 3D virtual model of the head to generate displays of the head from different viewing angles as if the head were seen from different points of view. The computer system may remove parts of the model so that other parts become visible. The computer system may highlight certain parts of the head so that those parts become more visible. The computer system may segment and highlight a particular portion of interest such as a target anatomic structure and add additional information such as measurements (e.g., distances, areas, volumes, etc.) and annotations into the virtual model.

Viewing and interacting with the virtual models generated from scanned data in this way can be of considerable use for surgical planning. For example, such techniques can allow a surgeon to diagnose the nature and extent of a patient's medical problems, and to decide upon the point and direction from which he or she should enter a patient's head to remove a tumor and minimize damage to the surrounding structure.

In known 3D visualization systems, computer software can be used to generate 3D volumetric views, providing a sense of shape and morphology (e.g., for the visualization of a coronary artery). Volumetric views can be generated through software reconstructions of a 3D image data set (e.g., using a volume rendering technique).

A visualization system can provide cross-sectional views in combination with a 3D volumetric view through dividing the display screen into a volumetric view section and multiple cross-sectional view sections. Using such a system, a user can interact with the volumetric view with a mouse. For example, the user can move the mouse, causing the visualization system to determine a position in the volumetric view, display the position in the volumetric view, and adjust one or more planes of the cross-sectional views accordingly.

Typically, the user is restricted to cut and view the volume along orthogonal axes (such as axial, sagittal, or coronal orientations). When the desired cut is not along orthogonal planes the user needs to specify oblique planes with the mouse, which is cumbersome, resulting in difficulties in controlling of the views and in interpreting the results. When the volume is cut to reveal surfaces, the cut in the volume may cause the 3D volumetric view to lose context, such as a reference structure, for comprehension. Further, the surfaces revealed from the cut may not be in an suitable orientation for viewing. Further, volume rendering parameters suitable for the visualization of the 3D structure may not be suitable for the display of surface structures revealed from the cut.

### SUMMARY

At least some embodiments of the disclosure include a data processing system which allows a user to interactively identify a portion of a volume and display the identified portion of the volume in a way that is particularly adapted for the visualization of the identified portion of the volume. For example, in response to user interaction, the data processing system can provide a 3D volumetric view of the volume. The 3D view shows a location inside the volume that is identified by a virtual tool. A view of the volume at the location is displayed in an orientation optimized for the viewing of the location. For example, a slice of a volume can be selected and displayed in an orientation that maximizes a displayed size and is consistent with the orientation of the slice in a 3D view of the volume.

One embodiment provides a method, that can be implemented on a data processing system, of: identifying a location of a volume based on input communicated via an input interface having at least 3 degrees of spatial freedom for input control; and displaying the volume and separately displaying a portion of the volume corresponding to the location. In one embodiment, the input interface includes a hand held device; and the displaying further comprises displaying a virtual tool corresponding to a location of the hand held device.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

FIGS. 1A-1F illustrate example scenarios of displaying a slice of a volume as identified by a virtual tool in a 3D view of the volume, in accordance with one embodiment;

FIGS. 2A-2B illustrate a user interface system having an input interface with at least 3 degrees of spatial freedom to control input, in accordance with one embodiment;

FIG. 3 illustrates a flow diagram of a process to generate a view of a portion of a volume, in accordance with one embodiment;

FIG. 4 illustrates a flow diagram of a process to sample a 3D volume on an identified surface, in accordance with one embodiment;

FIG. 5 illustrates a flow diagram of a process to determine an orientation for the display of a slice, in accordance with one embodiment;

FIG. 6 illustrates a method to compute an orientation, in accordance with some embodiments;

FIG. 7 illustrates a location of the slice viewer in a 3D space, in accordance with one embodiment;

FIGS. 8A-8D illustrate a zooming effect in a slice viewer, in accordance with one embodiment;

FIGS. 9A-9B illustrate a use of a slice viewer for marking and measuring in a volume, in accordance with one embodiment;

FIGS. 10A-10B illustrate another use of a slice viewer for marking and measuring in volume, in accordance with one embodiment;

FIGS. 11A-11C illustrate a use of multiple slices within a volume, in accordance with one embodiment;

FIGS. 12A-12B illustrate localized image processing applied to a slice displayed in a slice viewer; and

FIG. 13 shows a block diagram example of a data processing system for displaying 3D views according to one embodiment.

### DETAILED DESCRIPTION

In the following detailed description of embodiments, reference is made to the accompanying drawings in which like references indicate similar elements, and in which is shown by way of illustration of specific embodiments. These embodiments are described in sufficient detail to enable those skilled in the art to practice the techniques disclosed herein, and it is to be understood that other embodiments may be utilized and that logical, mechanical, electrical, functional, and other changes may be made without departing from the scope of the present inventions. The following detailed description is, therefore, not to be taken in a limiting sense, and the scope of the present disclosure is defined only by the appended claims.

### Introduction

The present disclosure provides various techniques for improved visualization of and interaction with 3D data image sets, such that the 3D data image sets can be explored and viewed in a user friendly, convenient way to allow better understanding of the 3D data image sets.

In various embodiments, a data processing system is used to interactively identify a portion of a 3D volume and display the identified portion of the volume in a way that is particularly adapted for the improved visualization of, and/or for the interaction with, the identified portion of the volume.

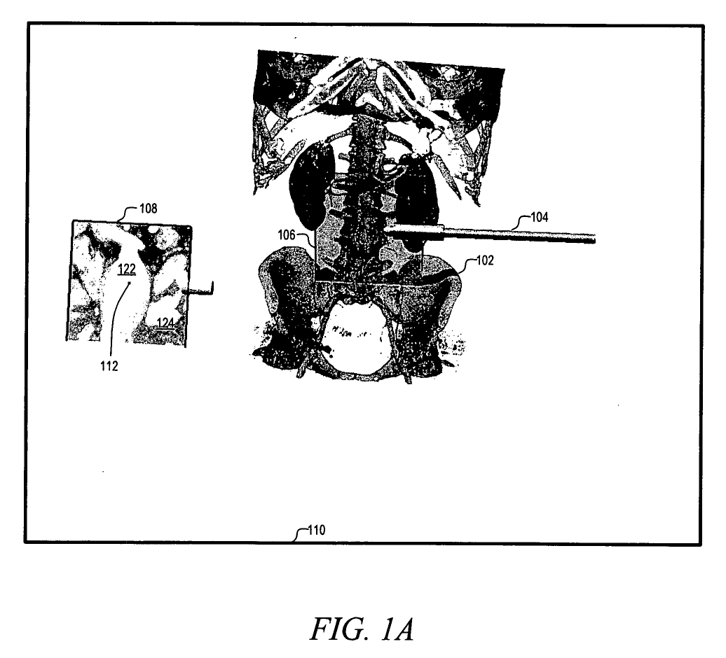

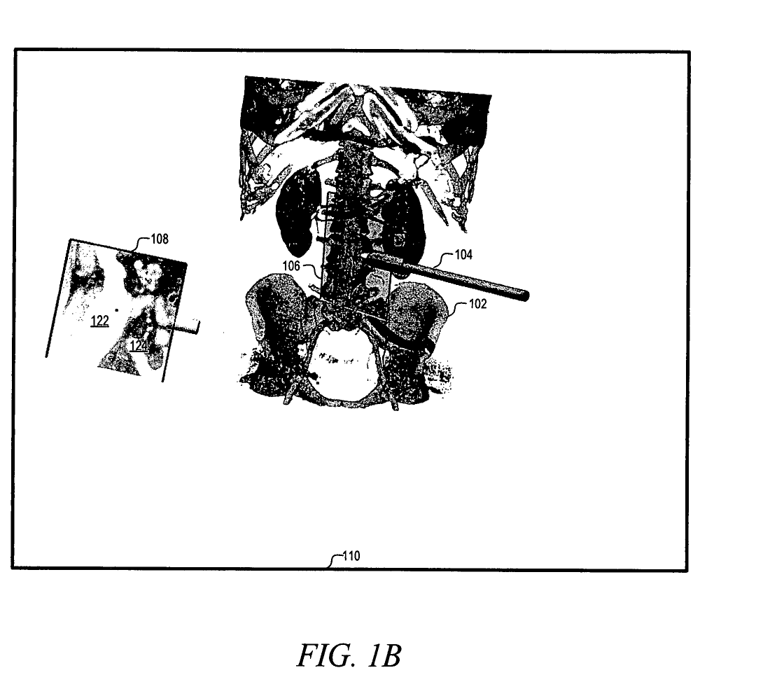

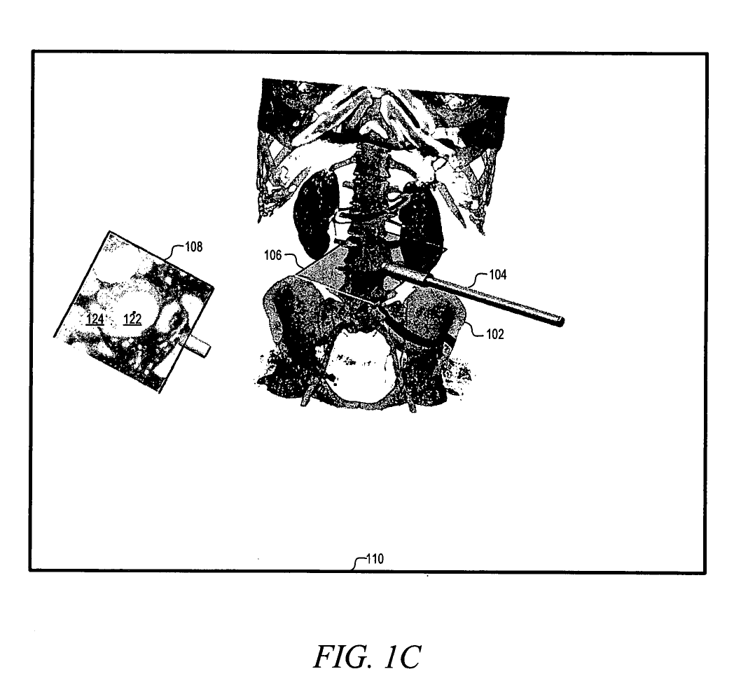

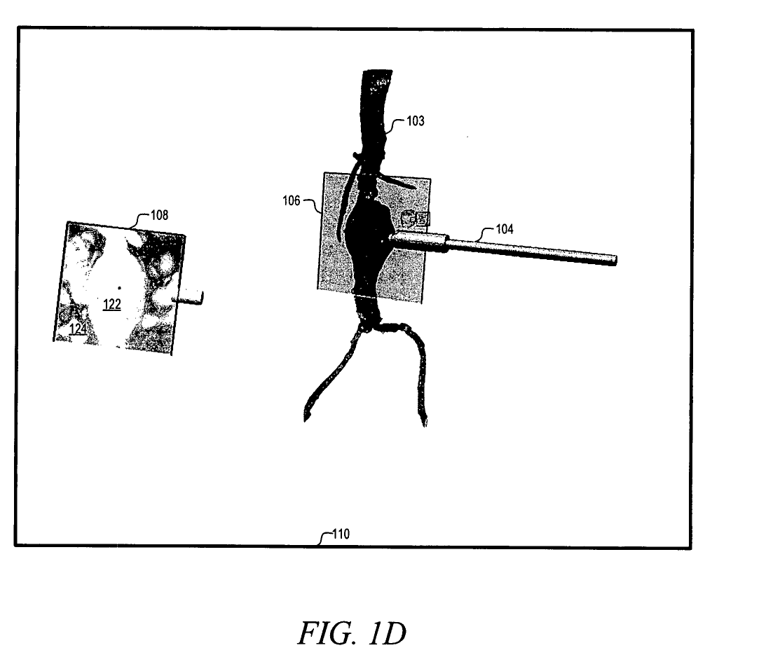

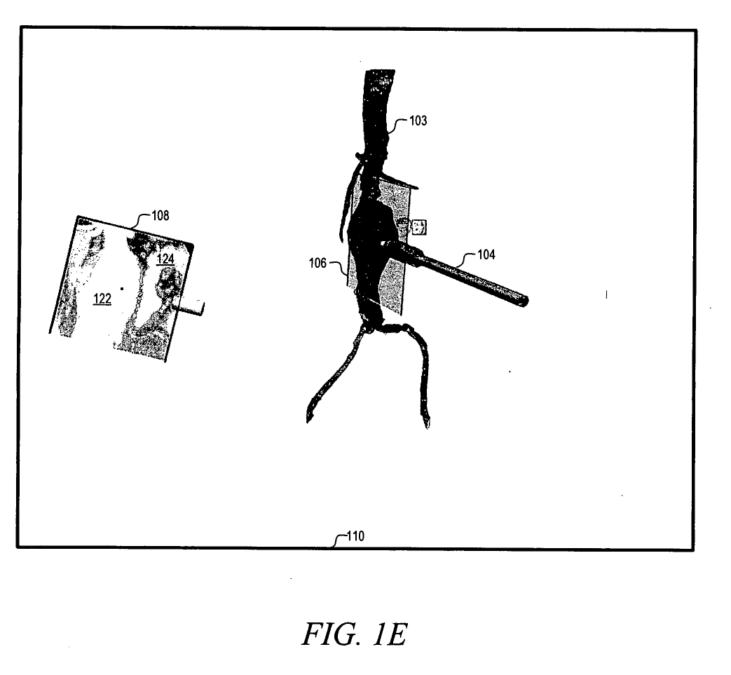

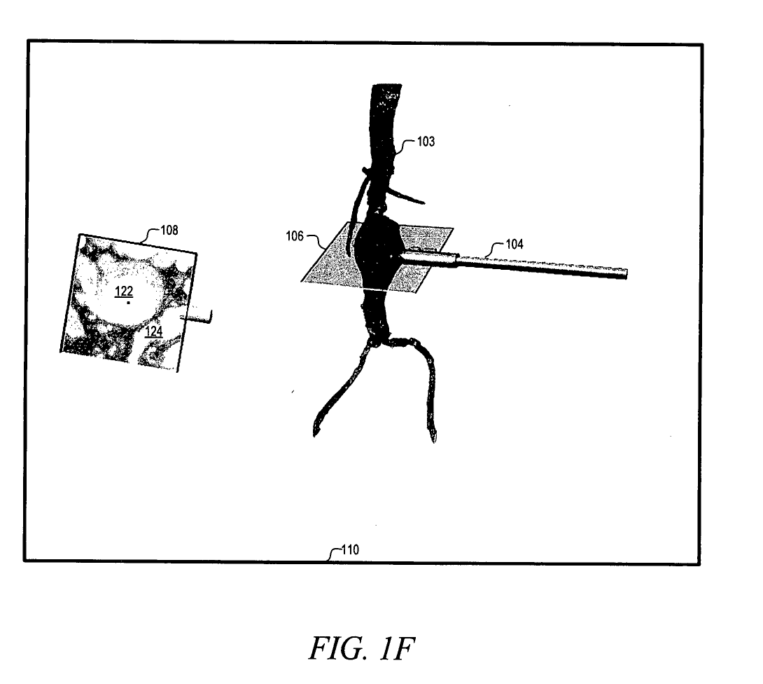

In one embodiment, as illustrated in FIG. 1A, a 3D medical image of a patient is displayed to provide a 3D view of the patient. The volume rendering parameters are adjusted to bring out the structure of the skeleton, kidneys, and aorta, etc., although the medical image data set also contains information for the tissues surrounding the structure that is depicted in the 3D view. A virtual tool 104 can be positioned relative to the structure in the 3D view to select a slice 106 that cuts through the aorta. The selected slice of the medical image is then displayed, separately from the structure, in a slice viewer 108. The slice viewer 108 is arranged to be parallel with the screen 110 and rotated within the plane of the screen 110 to have an orientation consistent with the orientation of the slice 106 as seen in the 3D view.

As illustrated in FIG. 1A, the virtual tool includes a partially transparent surface 106 with defined boundaries (e.g., the red, yellow, green and cyan edges). The intersecting portion between the surface 106 of the virtual tool and the volume is determined by the computer as a slice selected by the virtual tool. As the virtual tool is moved and rotated in a 3D space in response to a 3D input interface having at least three degree of spatial freedom for input control, such as a free-moving location-tracked stylus, the location of the surface 106 in the volume is changed. The slice of the volume, as identified by the then-current intersection portion of the surface 106 and the volume, is sampled and displayed separately from the volume in a slice viewer 108.

The slice viewer can be arranged to have an orientation for enhanced visualization results. The slice viewer can also be displayed at a location to provide an improved interface for interacting with the slice on a 2D surface.

In some embodiments, the slice viewer is used as a platform to provide an interface for various visualization and interaction activities, such as zooming, measuring, marker placing, segmentation, editing, image enhancing, etc.

A display of the 3D volume can be computed from one or more 3D image data sets that represent the 3D volume. A 3D view provides a depth dimension while a 2D view generally does not.

A 3D image data set specifies an intensity parameter as a function of a number of points distributed in a 3D space. The number of points are generally not within a single planar surface; and thus the image data set is considered as a 3D image data set. One representation of a 3D image data set can be a stack of slices sampled at different planes.

A typical 2D image data set specifies an intensity parameter as a function of a number of points that are all on a single planar surface. An area of such a planar surface within a 3D volume can be called a slice of the volume, although in general a slice does not have to be on a planar surface. In the present disclosure, a slice can also be sampled from a curved plane.

A 3D volume as represented by a 3D image data set can be displayed as a 3D view that generally provides a depth dimension. In one embodiment at least some points depicted in the 3D view are not in a single planar surface of the 3D volume. A 2D view generally shows points from a plane of 3D volume displayed. A 2D view does not provide a depth dimension.

To show a sense of depth, the 3D volume can be displayed in a 3D view as if it is seen from a point in space relative to the 3D volume. To provide a better sense of depth, the 3D volume can be displayed in a stereoscopic 3D view, as if it is seen from two points in the space, each corresponding to one of the eyes of an observer. Various techniques, such as shutter glasses, polarized glasses, anaglyph glasses, can be used for stereoscopic viewing.

Known computational methods can be used to generate a 3D view from a 3D image data set for display on a display screen. For example, a maximum intensity projection (MIP) method can be used to generate a projection of the 3D volume on a plane for display. A maximum intensity projection (MIP) is suitable to visualize high intensity structures in a 3D volume. Alternatively, a minimum intensity projection can be used to visualize low intensity structures in the 3D volume. Alternatively, a direct volume rendering method can be used to project the volumetric information from the volume onto a plane. Surface rendering techniques can also be used to generate a 3D view of the surface of 3D objects.

### Slice Viewer

FIGS. 1A-1F illustrate example scenarios of displaying a slice of a volume as identified by a virtual tool in a 3D view of the volume, in accordance with one embodiment.

In FIGS. 1A-1C, a 3D view of the volume 102 is displayed with a virtual tool. The virtual tool has a “handle” 104 and a partially transparent planar surface 106 that defines the size, shape and orientation of a slice to be selected. The slice selected from the volume is at the intersection between the planar surface 106 and the volume 102. The surface 106 is displayed with the volume 102 in the 3D view such that the user can see the portion of the volume that is being sampled for viewing in a separate slice viewer 108.

In FIGS. 1A-1F, the surface 106 is attached to the handle 104; and the tip of the handle 104 is at the center of the surface 106. The position and orientation of the handle, and thus the position and orientation of the surface 106, can be adjusted according to input communicated via an input interface, such as a free-moving location-tracked stylus. Preferably, the position and orientation of the handle 104 in the 3D view correspond to the position and orientation of a tracked stylus in a workspace; thus, as the user moves the stylus in the workspace, the handle 104 and the surface 106 move accordingly in the 3D view. Preferably, the position of the tip of the handle 104 corresponds to the position of the tip of the tracked stylus.

In FIGS. 1A-1F, the tip of the handle 104 is at the center of the surface 106. In FIG. 1A, the red dot 112 in the slice viewer 108 represents the position of the tip of the handle 104 in the slice.

In FIGS. 1A-1F, the surface 106 is generally in an angle with the display screen 110. The projection of the surface 106 on the display screen is typically rotated and deformed. For example, the projection of the surface 106 on the screen has a near square shape in FIG. 1A; however, the projection of the surface 106 on the screen does not have a square shape in FIG. 1C. From FIG. 1A to FIG. 1B to FIG. 1C, the projection of the surface 106 on the screen is deformed and rotated in a clockwise direction; however, the slice viewer 108 is rotated in the clockwise direction without deformation.

For a better visualization result, the slice viewer 108 is arranged within a plane on the screen 110 (or a plane parallel to the screen 110) to present the slice that is selected by the surface 106.

To assist the user in correlating the content in the slice viewer 108 and the structure in the 3D view of the volume 102, the slice viewer 108 preferably includes a portion of the handle to indicate the orientation of the displayed slice in relation with the orientation of the surface 106. Further, the slice viewer 108 preferably includes differently colored boundaries (e.g., red, yellow, green, cyan, etc.), which correspond to the differently colored boundaries of the surface 106. The handle and colored edges of the surface of the virtual tool and the corresponding representations on the slice viewer can be considered as orientation markers, which are helpful to a user in recognizing the orientation of the surface of the virtual tool and/or correlating the content in the slice viewer 108 and the structure in the 3D view of the volume 102.

As illustrated in FIGS. 1A-1F, the surface 106 of the virtual tool intersects with the volume at different locations, as the tool is moved and rotated in the 3D view. The system samples the volume to obtain a 2D image data set that represents the slice of the volume at the location of the surface 106. The 2D image data set is displayed in the slice viewer 108 separately from the volume 102 to provide an improved direction of viewing for the sampled slice. Thus, the user can simultaneously view the sampled slice, sampled from the intersection between the partially transparent surface 106 and the volume 102, and view the position and orientation of the surface 106 relative to the volume 102.

In FIGS. 1A-1C, the rendering parameters are selected to bring out the 3D structures, such as the skeleton, kidneys, and aorta. At least some of the tissues are set to be invisible. Thus, it appears that the surface 106 intersects with only a small portion of the volume 102, since the surrounding tissues are not rendered in the 3D view. The sampled slice includes the tissue data. For example, in FIG. 1A, the tissue structure in area 124 is also displayed.

The slice viewer 108 provides a view of a sampled slice of the volume. The slice can be selected at a position and orientation as specified by the virtual tool without restriction to any axis. Thus, the slice viewer and the virtual tool can be used to explore the inside structure of the volume with a combination of a 3D view of the volume 102 and a 2D view of a selected slice inside the slice viewer 108, in at least one embodiment.

As illustrated in FIGS. 1A-1C, the rotation of the slice viewer is constrained within a plane parallel to the display screen 110, while the surface 106 of the virtual tool is allowed to rotate in any direction in the 3D view of the volume 102. When the partially transparent surface 106 rotates in the 3D view (e.g., as illustrated in the series of figures from FIG. 1A to FIG. 1B to FIG. 1C), the rotation of the slice viewer 108 within the plane of the screen is determined based on the orientation of the surface 106; and the slice viewer 108 is rotated within the screen plane in an angle consistent with the rotation of the projection of the surface 106 on the screen plane. Thus, the slice viewer 108 and the surface 106 of the virtual tool appear to be in a closely aligned orientation. Such an arrangement helps the user to correlate the content as seen in the slice viewer with the structure depicted in the 3D view of the volume.

For example, consider that the surface 106 of the virtual tool is within a plane that is parallel to the screen. When the surface 106 rotates within the plane by an angle T, the slice viewer 108 is also rotated within its plane by an angle T, such that the slice viewer 108 and the surface 106 have the same orientation.

However, in one embodiment, the rotation of the slice viewer 108 is within the screen plane, to provide an improved viewing direction to the sampled slice presented in the slice viewer. The surface 106 is allowed to rotate in any direction to select a slice. Thus, the rotation of the slice viewer 108 is computed from the orientation of the surface 106.

For example, the normal of the planar surface 106 is generally not perpendicular to the screen plane. To bring the normal of the planar surface 106 to the direction that is perpendicular to the screen plane, the planar surface 106 can be rotated about an axis that is perpendicular to both the normal of the planar surface 106 and the normal of the screen plane. Thus, the sampled slice is then presented in the screen plane with an orientation that is the same as the rotated sliced.

Alternatively, the slice viewer can be presented at a fixed orientation, regardless the orientation of the surface, although such an arrangement is generally not as user friendly as presenting the slice viewer in an orientation consistent with that of the surface 106.

In volume rendering a 3D image data set, rendering parameters can be adjusted to view certain structures inside the volume while hiding other structures, as illustrated in FIGS. 1A-1C. Further, different 3D image data sets can be co-registered to represent the volume. One or more of the co-registered 3D image data sets can be used to provide the 3D view for the selection of a desired slice; and the slice viewer can be used to display the corresponding slice from one of the co-registered 3D image data sets, or a combined slice from the co-registered 3D image data sets. FIGS. 1D-1F illustrate a volume 103 that is segmented from the volume 102 in FIGS. 1A-1C.

In one example, the 3D image data set for the volume 103 is generated from a segmentation operation on the volume 102. The 3D image data set of the volume 102 is imaged after a contrast fluid is injected in the main vessel (aorta). A segmentation operation is performed on volume 102 to extract a 3D image data set that represents the lumen in the main vessel (aorta), based on an imaging property of the contrast fluid. The new 3D image data set that is segmented from the original 3D image data set can be displayed, as illustrated in FIGS. 1D-1F, to guide the selection of slices. Alternatively, a surface model can be extracted to represent the main vessel and displayed in a 3D view to guide the selection of slices.

In FIGS. 1D-1F, the volume rendering does not show the tissue outside the lumen. The 3D view of the lumen shows the 3D shape of the main vessel (aorta), which can be useful in selecting a desired location for slice viewing.

Although FIGS. 1A-1C and FIGS. 1D-1F present different 3D views based on different 3D image data sets, the location as identified by the virtual tool can be used to access a same 3D image data set to generate the display of the selected slice, since the 3D image data set are co-registered. In the slice viewer 108 in FIGS. 1A-1F, the white part 122 corresponds to the lumen in the vessel 103; and the grey part 124 corresponds to the surrounding tissues.

Thus, a user has the option to use a 3D display of a CT image to guide the selection of a slice in a co-registered MRI image. Further, the slice viewer can be configured to combine corresponding slices from co-registered MRI and CT images to provide an enhanced view of the structure at the slice. Image fusion, filtering, enhancing, etc., can be performed within the slice viewer.

In one embodiment, the size and/or the shape of the surface 106 is user adjustable or selectable (e.g., via a user interface such as a slider, menu options, etc.). Further, the size of the slice viewer 108 is also adjustable or selectable in dependent from the size of the surface 106. Since the content sampled at the surface 106 fills the slice viewer 108, adjusting the size ratio between the surface 106 and the slice viewer 108 can provide a zooming effect, which is discussed in more detail below.

### User Interface System

As stated above, a virtual tool can be positioned according to user input. Preferably, an input interface that is capable of providing direct 3D spatial input is used to position the virtual tool.

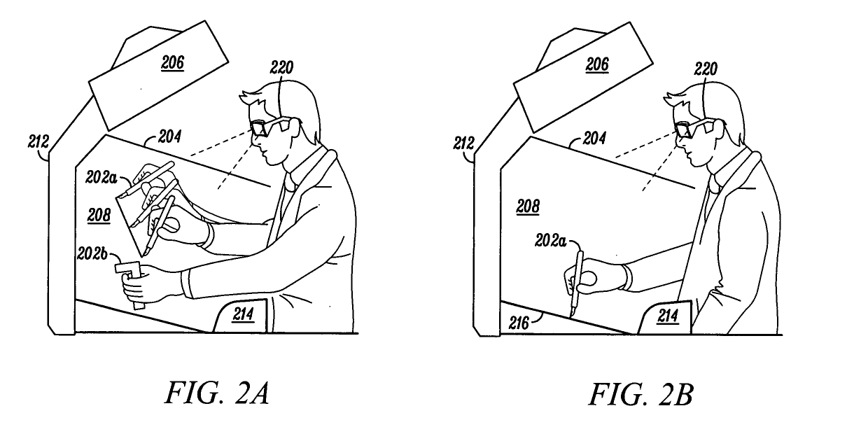

FIGS. 2A-2B illustrate a user interface system having an input interface with at least 3 degrees of spatial freedom to control input, in accordance with one embodiment.

In FIGS. 2A-2B, the user interface system includes one or more handheld instruments 202a-b, such as a position tracked stylus 202a and a 6D controller 202b having a shape of a joystick. The user interface system allows the user to freely maneuver the handheld instruments in the workspace 208 to provide 3 or more degrees of spatial freedom of input control.

In one embodiment, the location of the stylus 202a in the workspace 208 is tracked using a electromagnetic tracker, a radio frequency (RF) tracker, a camera-based tracker, or other types of trackers known in the field. The location of the stylus 202a in the workspace 208 is used as input control.

Preferably, in a typically user interaction mode, the position and orientation input from the 6D controller is used to control the position and orientation of the volume in the 3D view; and the location of the stylus controls the corresponding location of the virtual tool. More preferably, the location of the tracked stylus in the workspace 208 is directly mapped to the location of the virtual tool in the 3D view, such that if the tracked stylus is returned to the same location in the workspace 208, the virtual tool also returns to the corresponding same location in the 3D view. More preferably, the perceived space in the 3D view (e.g., as seen from a stereoscopic display) coincides with the workspace 208.

Optionally, the input interface can include a haptic device in providing input control with the one or more handheld devices.

In FIGS. 2A-2B, a mirror 204 is placed between the display device 206 and the workspace 208. The mirror reflects the display screen such that the 3D view of the volume and the virtual tool, as displayed by the display screen, is perceived to be in the workspace 208, when the display device 206 is viewed via the mirror 204.

In one embodiment, the display device 206 provides a stereoscopic display of the 3D view. When viewed via the mirror 204 through a pair of 3D stereoscopic glasses 220, the user perceives that the volume and the virtual tool in the 3D stereoscopic view, as displayed on the display device 206, is virtually in the 3D workspace 208.

Preferably, the stereoscopic view is displayed using an alternate-frame sequencing technique; and liquid crystal display (LCD) shutter glasses 220 are used to observe the stereoscopic view. Multiple viewers can wear shutter glasses to simultaneously view and discuss the volume. Alternatively, the stereoscopic view can be displayed and viewed via other techniques, such as polarized glasses, anaglyph glasses, etc.

Thus, via the mirror reflection of the stereoscopic display produced on the display device 206, the volume, virtual tool and other objects (e.g., slice viewer) are perceived to be virtually in the workspace 208.

Preferably, the scale of the 3D stereoscopic display is configured to be the same as and aligned with the 3D workspace 208, such that the position and orientation of the handheld device 202a in the workspace 208 match the perceived position and orientation of the virtual tool. Since the volume as displayed is also perceived to be in the workspace 208, the arrangement of FIGS. 2A-2B provides a sensation of hand access to the volume that is displayed.

The user's hands are allowed to move freely in the workspace 208 that is behind or under the mirror 204. Using the stylus 202a, the user can interact with the volume that is perceived to be in the workspace 208. The user is able to manipulate the volume with both hands in the workspace 208, via the handheld instruments, without obscuring the volume that is perceived to be in the workspace 208 (since the workspace 208 is behind the mirror 204).

In one embodiment, the user interface system further includes a workstation 212 with a support 214 upon which the user's arm can rest.

In one embodiment, the 6D controller has a graphical representation in the displayed 3D view, such as a 3D cross hair cursor. The spatial movement and rotation of the 6D controller causes the system to move and rotate the 3D cursor in the 3D view accordingly. A user can move the cursor to the volume, press and hold down a button on the 6D controller, and move and/or rotate the 6D controller while holding the button to cause the system to move and rotate the volume in the 3D view. This arrangement provides a sensation of reaching a hand into the workspace, grabbing the volume as perceived in the workspace, and moving and rotating the volume to adjust the position and orientation of the volume in the workspace. After the user releases the button on the 6D controller, the movement of the 6D controller is used to control the movement of the cursor but not used to move the volume in the 3D view, providing a sensation of releasing the grab on the volume and moving the hand to other locations in the workspace.

In one embodiment, the system is also capable of displaying a virtual tool panel inside the 3D stereoscopic view. The virtual tool panel provides graphical user interface elements such as buttons, sliders, editors, menus, entry boxes, etc., to control applications, select tools, change operation modes, specifying parameters, etc.

Preferably, as illustrated in FIG. 2B, the virtual tool panel is displayed such that the panel is perceived to be at a location coincides with a solid surface base 216 beneath the workspace 208. With the physical support of the ergonomically-angled solid surface base 216, the user can operate on the virtual tool panel precisely using the stylus 202a with ease.

In one embodiment, when the system determines that the tip of the stylus 202a is in the vicinity or on the solid surface base 216 (e.g., within a threshold value of distance), the virtual tool panel is displayed. A representation of the virtual tool is also displayed to have a perceived location that coincides with the location of the stylus 202a. The user can select a user interface element of the virtual tool panel through positioning the tip of the stylus 202a in the region corresponding to the user interface element (e.g., a slider or a button). One or more buttons on the stylus 202a can be used to activate the selected user interface elements.

Thus, in one embodiment, the virtual tool panel is presented in response to the handheld tool 202a touching the solid surface base 216; and the virtual tool panel disappears after removing the handheld tool 202a from the base. The virtual tool panel allows user interactions to push buttons, drag sliders, edit curves, drop down menus, and the like, similar to those in available in 2D conventional graphical user interface systems.

As a result, the user interface system as described and illustrated in FIGS. 2A-2B provides a stereoscopic Virtual Reality (VR) environment, which allows a user to work interactively in real-time with 3D data by “reaching into it” with both hands.

In one embodiment, the system as illustrated in FIGS. 2A-2B is configured for the visualization of medial images. In one embodiment, the system is able to generate real-time volumetric and 3D spatial surface rendering of images based on one or more imaging modalities (e.g., in Digital Imaging and Communications in Medicine (DICOM) format), such as computer tomography (CT), positron emission tomography (PET), single-photon emission computer tomography (SPECT), magnetic resonance imaging (MRI), magnetic resonance angiography imaging (MRA), volumetric ultrasound, and as well as segmentations obtained from one or more of the multimodal images. The 3D image data set can be rendered for display in a perspective stereoscopic shaded format, such that the content of the displayed image set can be perceived to be virtually in the workspace 208, into which the user can reach both hands for interaction via the handheld tools 202a-b.

In one embodiment, image data sets from different modalities can be registered with each other using various image registration methods available in the field. The system can display the image data sets in a comparative mode to allow a user to visually inspect the accuracy of registration. See, for example, U.S. patent application Ser. No. 10/725,772, the disclosure of which is hereby incorporated herein by reference. Different colors and/or transparency mapping can be selectively applied to different image data sets. After the image registration process, different image data sets can be optionally merged into a single set through image fusion. Volumetric objects can also be created from 3D image data sets through segmentation operations via various techniques such as thresholding, marching cubes, or dividing voxels. U.S. patent application Ser. No. 10/998,379 describes methods of dividing voxels, the disclosure of which is hereby incorporated herein by reference. Further, surface models can be extracted from the 3D image data sets and rendered for display with optional color shading.

In one embodiment, surgical planning can be performed based on the visualization of the 3D image data sets. For example, virtual tools for cropping, cutting, drilling, restoring, cloning, etc., can be used in developing a surgical plan. Linear and volumetric measurements can be performed via the interaction with the 3D display of the image data sets.

In one embodiment, 3D user interactions with the system can be captured via an input logger and re-enacted using the logged input to re-generate the corresponding display. Further, the recorded user interactions can be exported as a video stream for viewing on a standard video device.

In alternative embodiments, more than two handheld devices may be provided. For example, multiple users may be able to interact with the volume, remotely or locally. In one embodiment, a single handheld device may be used to perform a set of the activities described above.

In one alternative embodiment, the space in which the volume and virtual tool are perceived to be, via the stereoscopic display, is separate from the workspace in which the handheld tools are operated. For example, the stereoscopic display are projected onto a screen via two projectors, one for projecting images for the left eye and one for projecting images for the right eye. The projected images are filtered with polarized filters; and one or more users can view the stereoscopic display using corresponding polarized glasses. The volume and virtual tool as displayed are perceived to be near with the screen. The handheld tools are operated near a console which is typically located in a distance away from the screen.

In one further alternative embodiment, the 3D volume and the virtual tool are displayed in a monoscopic mode to reduce requirements on display equipment and viewing devices, at an expense of reduced sense of depth and precision in 3D.

### Computation Process

In one embodiment, the portion of the volume as specified by the virtual tool is sampled and displayed (e.g., in a slice viewer) in real time or near real time as the user interacts with the input interface (e.g., the location-tracked stylus) in the workspace. After the location of the slice is determined based on the input from the input interface, the slice is sampled based on an interpolation of the volume. After the orientation of the slice viewer is determined and slice is sampled, the sampled slice is displayed inside the slice viewer.

In one embodiment, the location (including the position and orientation) of the input interface in the workspace and the location of the virtual tool in the 3D view has a one-to-one mapping. When two different coordinate systems can be used to represent the tracked location and the locations in the space of the 3D view, the position and the orientation of the virtual tool relative to the volume in the 3D view are computed from the tracked location of the input interface in the workspace and the mapping between the workspace and the space of the 3D view.

Alternatively, the system stores the current location of the virtual tool and updates the location of the virtual tool according to user input. The display of the virtual tool in 3D provides a feedback to the user.

Typically, the image data for the 3D volume is represented in a local coordinate system of the volume. For convenience, the position and orientation of the virtual tool relative to the volume can be further converted into the local coordinate system of the volume to sample the volume. Based on the size and shape of the portion identified by the virtual tool, a set of sample points within the identified portion are interpolated based on the 3D image data set of the volume.

For example, when the virtual tool identifies a rectangular slice, a rectangular array of pixels on the slice are sampled. According to the size, position and orientation of the slice, the position of each of the pixels in the local coordinate system of the volume can be computed. An interpolation scheme can then be used to interpolate the 3D image data set and obtain the intensity value at each pixel, respectively.

For example, a trilinear interpolation scheme can be used to interpolate a sampled pixel from eight neighboring voxels that box in this pixel, when the 3D image data set is represented as intensity values on a 3D array of voxels. Alternatively, high order interpolation schemes and spline interpolation schemes can also be used.

In one embodiment, the sampling of the volume for the selected portion is performed at a resolution that is substantially the same as the resolution of the 3D image data set to avoid under-sampling or over-sampling.

The selected portion of the volume is sampled to create an image data set for the portion of the volume. The created image data set can be displayed separately from the volume (e.g., in a slice viewer) with or without further processing.

In one embodiment, the orientation of the slice viewer is also computed based on the orientation of the virtual tool, as previously described. For example, as illustrated in FIG. 1A, the slice viewer 108 is rotated within the screen plane to have an orientation consistent with the orientation of the surface 106.

For example, a desired orientation of the slice as shown in the slice viewer 108 can be determined through rotating the surface 106 about an axis that is perpendicular to both the normal of the surface 106 and the normal of the screen plane until the normal of the rotated slice is parallel to the normal of the screen plane. After the orientation of the rotated slice is determined, the slice viewer is rotated within the screen plane to display the sampled slice in an orientation that is the same as the rotated slice. For example, the sampled content can be mapped into the area of the rotated slice viewer (e.g., using a texture mapping functionality).

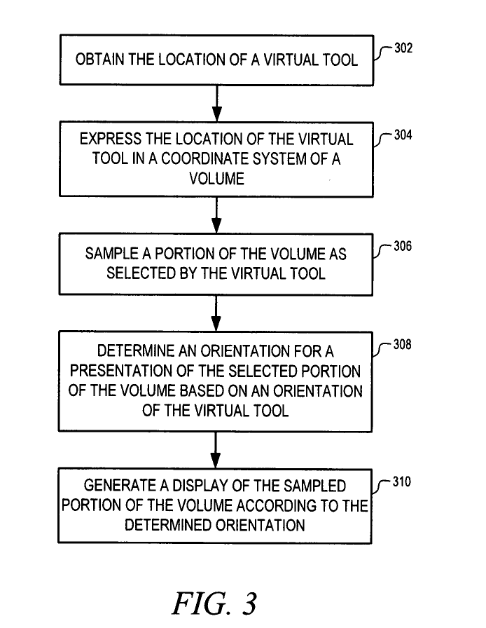

FIG. 3 illustrates a flow diagram of a process to generate a view of a portion of a volume, in accordance with one embodiment. In FIG. 3, the location of a virtual tool is obtained 302 (e.g., the orientation and position in a world coordinate system). In one embodiment, the orientation and position of the virtual tool can be derived from the orientation and position of the handheld tool (e.g., 202a), which is preferably obtained from a location-tracking device.

The location of the virtual tool (e.g., the orientation and position of the partially transparent surface 106) is then expressed 304 in a coordinate system of a volume. Therefore, the sampling of the portion as selected by the virtual tool can be performed in the convenience of the coordinate system of the volume.

A portion of the volume as selected by the virtual tool is then sampled 306 to generate sampled image data. For example, the selected portion can be the intersection between the surface 108 of the virtual tool and the volume 102 in FIG. 1A; and the intersection are in the 3D view is sampled as a 2D slice in a slice viewer 108.

After an orientation for a presentation of the selected portion of the volume is determined 308 based on an orientation of the virtual tool, a display of the sampled portion of the volume is generated 310 according to the determined orientation. For example, instead of showing the slice in a fixed orientation in a separate window regardless the orientation of the virtual tool, the slice viewer 108 in FIG. 1A is presented in an orientation similar to the orientation of the surface 106 of the virtual tool. Thus, a user can more easily correlate what is displayed in the slice viewer 108 and what is in the volume 102.

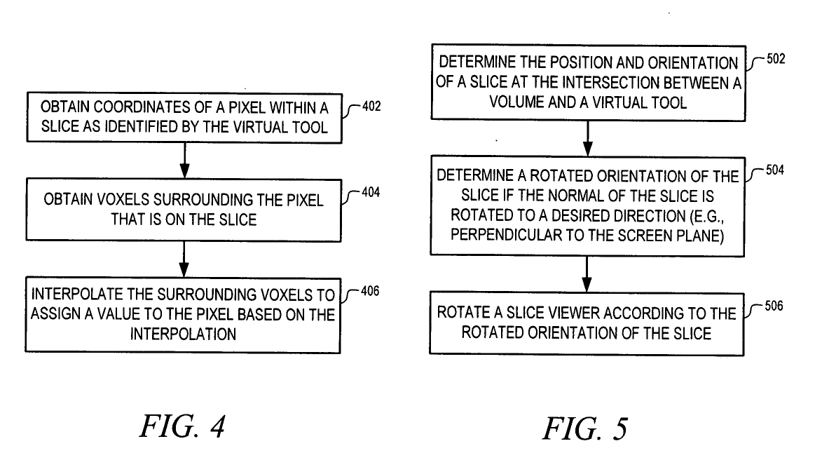

FIG. 4 illustrates a flow diagram of a process to sample a 3D volume on an identified surface, in accordance with one embodiment. The process can be used in operation 306. In FIG. 4, the coordinates of a pixel within a slice as identified by the virtual tool are obtained 402, based on the location of the virtual tool relative to the volume and the size and shape of the surface 106 of the virtual tool. The voxels surrounding the respective pixel that is in the slice are obtained (404). The surrounding voxels are interpolated (406) over a region which contains the respective pixel, to assign a value to the pixel based on the interpolation. A trilinear interpolation scheme, spline interpolation scheme, or other interpolation schemes can be used. The operations 402-406 are repeated for remaining pixels of the slice.

FIG. 5 illustrates a flow diagram of a process to determine an orientation for the display of a slice, in accordance with one embodiment. The process can be used in operation 308. In FIG. 5, the position and orientation of a slice at the intersection between a volume and a virtual tool is determined (502). A rotated orientation of the slice is determined (504) if the normal of the slice is rotated to a desired direction. For example, the normal of the slice can be rotated to a direction that is perpendicular to the screen plane. A slice viewer is then rotated (506) according to the rotated orientation of the slice for the presentation of the slice. Thus, the slice viewer is presented in an orientation that is the same as the rotated orientation of the slice, as if the slice were rotated from the intersection plane to a plane having a desired normal direction, such as a plane parallel to the screen plane. Thus, the slice viewer is orientated in a direction consistent with the orientation of the surface of the virtual tool in the 3D view.

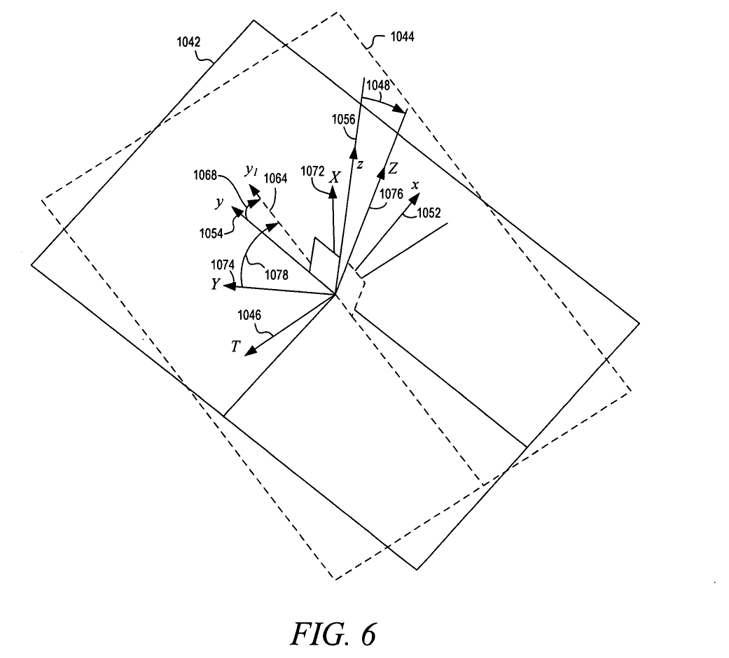

FIG. 6 illustrates a method to compute an orientation, in accordance with some embodiments. To determine the desired orientation of the slice viewer, the slice 1042 at the intersection between the volume and the virtual tool is hypothetically rotated. In FIG. 6, a slice 1042 is rotated to an orientation within the plane 1044 such that the normal of the slice 1042 is rotated 1048 from the direction about the z-axis 1056 to a desired direction along the Z-axis 1076, such as a direction that is perpendicular to the screen plane. In one embodiment, the rotation of the slice is about the T-axis 1046 that is perpendicular to both the z-axis 1056 and the Z-axis 1076. The T-axis 1046 is along the direction of the intersecting line between the plane of the slice 1042 and the plane 1044.

For example, consider that the x-axis 1052 and the y-axis 1054 are axes within the slice 1042, which are used to identify the orientation of the slice 1042. As the slice 1042 rotates 1048 about the T-axis 1046, the y-axis 1054 rotates 1068 about the T-axis 1046 to the direction along the y₁-axis 1064. The y₁-axis 1064 is within the plane 1044. The y₁-axis 1064 identifies the rotated orientation of the slice within the plane 1044. Consider that the X-axis and Y-axis are reference axes with the plane 1044. The orientation of the y₁-axis 1064 relative to the Y-axis can be determined (e.g., by the angle of rotation 1078 within the plane 1044). Thus, after the orientation of the y₁-axis 1064 within the plane 1044 is computed, the slice viewer can be rotated within a plane that is parallel to the plane 1044, such that the slice as shown in the slice viewer has the same orientation as the rotated slice in the plane 1044.

Alternatively, two orthogonal axes are projected to a desired plane (e.g., the screen plane), along the normal of the desired plane, from a slice that is at the intersection plane between the virtual tool and the volume. The average of the rotations of the projection of the axes within the screen plane is computed. A slice viewer is rotated according to the computed average in the screen plane for the presentation of the slice.

In one embodiment, the position of the slice viewer on the screen can also be specified by a user through dragging the slice viewer to desired location. For example, a user can operate a cursor controlling device to move a cursor to the slice viewer, activate a switch such as a button on the cursor controlling device or a key, and operate the cursor controlling device to cause the system to move slice viewer with the cursor, and then release the switch. The system then presents the slice viewer at that position.

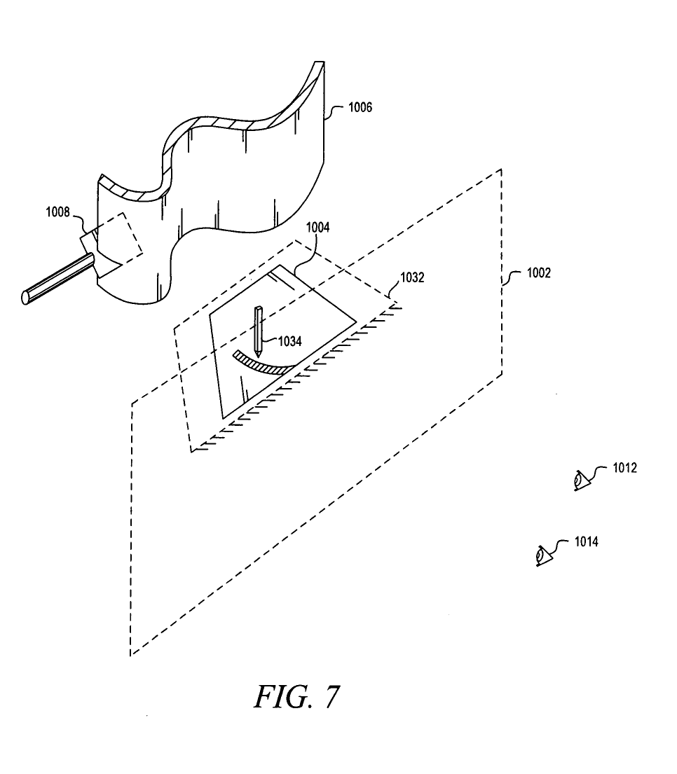

In FIG. 7, the slice viewer 1004 is placed on a plane 1032 that coincides with a solid surface, such as surface 216 in FIG. 2B of the user interface system. Since the solid surface provides physical support for the stylus, a user can interact with the slice viewer 1004 using a stylus with precision and ease. To interact with the slice viewer 1004, a user can first position the virtual tool 1008 at the desired location and then activate a mode change to allow the stylus to be disassociated from the virtual tool 1008 and associated with another virtual tool 1034, which tracks the position and orientation of the stylus while the user interacts with the slice viewer 1004. The user may place markers in the slice viewer, select points, draw curves, etc., described in more details below.

In one embodiment, the slice viewer 1004 is displayed as part of a virtual interface panel, which can include various user interface elements such as buttons, sliders, menus, etc. Thus, the user can easily select various options while working with the slice viewer 1004, with the support of the solid surface.

### Slice Viewer Interactions

Zooming

In one embodiment, a user can increase or decrease a magnification of the image shown within a slice viewer through adjusting the size of the slice viewer and/or the size of the surface of the virtual tool that is used to select the slice. The content sampled in the slice as identified by the surface of the virtual tool fills the slice viewer. Thus, increasing the size of the slice viewer while keeping the size of the portion of the volume selected by the virtual tool constant effectively increases the magnification; decreasing the size of the portion of the volume selected by the virtual tool while keeping the size of the slice viewer constant effectively increases the magnification.

In one embodiment, the size of the slice viewer and the size of the surface of the virtual tool can be adjusted through adjusting preference settings in a virtual tool panel. For example, a slider can be used to continuously adjust the sizes. Alternatively, the sizes of the slice viewer and the surface of the virtual tool can be adjusted interactively when the system is placed into a mode to adjust the sizes. Alternatively, keyboard short cuts can be used to adjust the sizes.

When the size of the surface of the virtual tool is fixed, the size of the portion of the volume selected by the virtual tool can also be adjusted by changing a magnification factor of the volume that is used to display the volume in the 3D view.

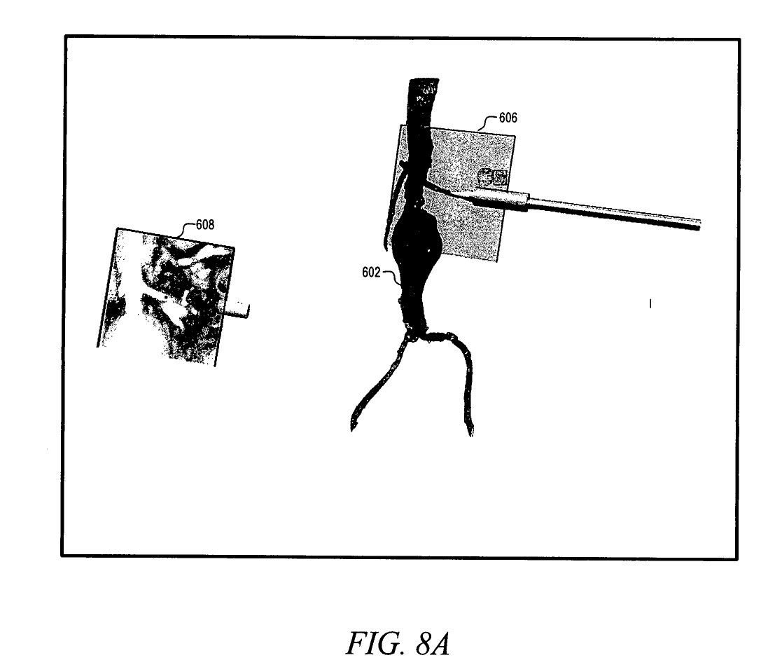

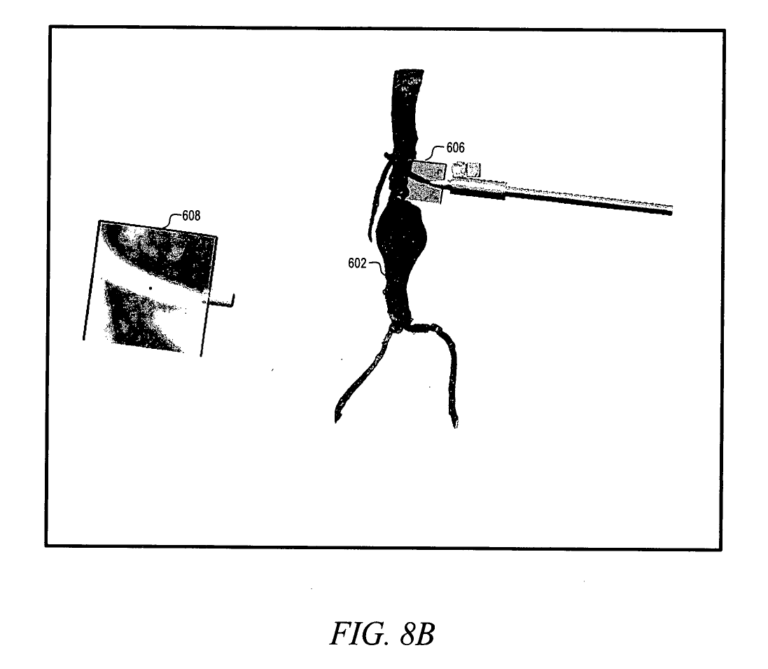

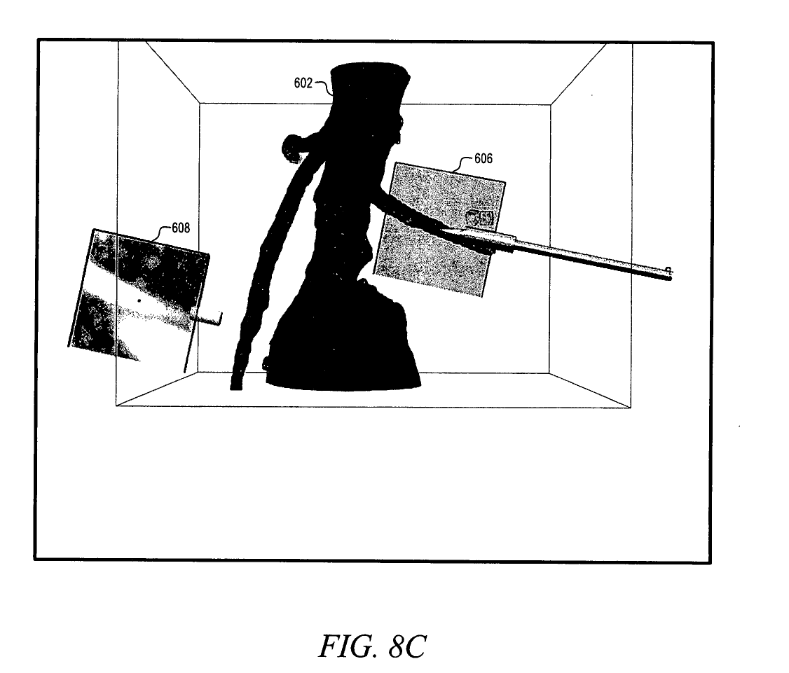

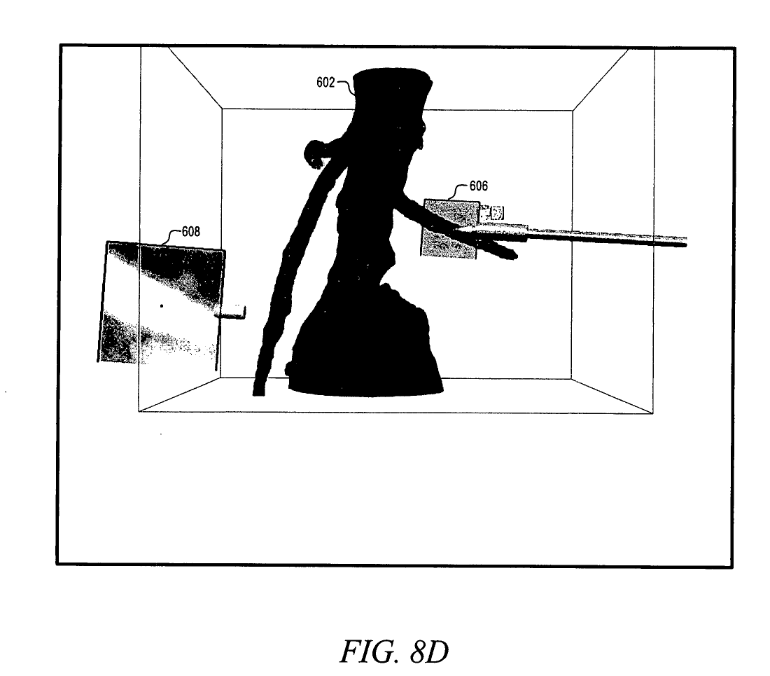

FIGS. 8A-8D illustrate a zooming effect in a slice viewer, in accordance with one embodiment. From FIG. 8A to FIG. 8B, the magnification (also referred to as the zooming effect) of the image within the slice viewer 608 is adjusted by maintaining a fixed size of the slice viewer 608, while adjusting the size of the surface 606 of the virtual tool. The size of the surface 606 of virtual tool in FIG. 8B is smaller than that in FIG. 8A. Thus, the surface 606 of the virtual tool in FIG. 8B selects a smaller slice of the volume for display in the slice viewer 608 than the surface 606 of the virtual tool in FIG. 8A. Effectively, the magnification of the image is shown in the slice viewer 608 in FIG. 8B is larger than that in FIG. 8A. As a result, the image within the slice viewer 608 of FIG. 8B appears to be magnified relative to the image within the slice viewer of FIG. 8A.

From FIG. 8A to FIG. 8C, the size of the surface 606 of the virtual tool and the size of the slice viewer 608 are the same. The volume is magnified (e.g., through a zoom in operation). Thus, a smaller portion of the volume 602 is selected by the surface 606 in FIG. 8C than in FIG. 8A. As a result, the image within the slice viewer 608 of FIG. 8C appears to be magnified relative to the image within the slice viewer of FIG. 8A

The user can effectively increase or decrease the magnification of the image as shown in the slice viewer 608 through adjusting the size of the slice viewer, adjusting the size of the surface 606, and/or adjusting a zooming factor for displaying the volume 602.

From FIG. 8D to FIG. 8C, the zooming factor for the display of the volume 602 is fixed. The size of the slice viewer 608 in FIG. 8D is the same as that in FIG. 8C. However, the size of the surface 606 in FIG. 8C is larger than the surface 606 in FIG. 8D. Thus, in FIG. 8C a larger portion of the volume 602 is selected for display in the slice viewer of the same size than in FIG. 8D. As a result, the image within the slice viewer 608 of FIG. 8C appears to be zoomed out relative to the image within the slice viewer of FIG. 8D.

In one embodiment, a slider is provided for a user to input the magnification adjustments, which may be performed as described above. In one embodiment, one or more sliders can be used to control the magnification of the volume 602, the size of the surface 606, and the size of the slice viewer separately. Thus, a user has the opportunity to view a slice of the same size with a large surface 606 intersecting with the volume 602 having a large magnification (a large volume size), or a small surface 606 in the volume 602 having a small magnification (a small volume size).

U.S. patent application Ser. No. 10/725,773 describes examples of using a zoom slider on a virtual tool panel to adjust the magnification for the display of a volume, the disclosure of which is thereby incorporated herein by reference.

Marker Placement and Measurements

In one embodiment, the slice viewer allows a user to place markers, landmarks or measurement points within a volume.

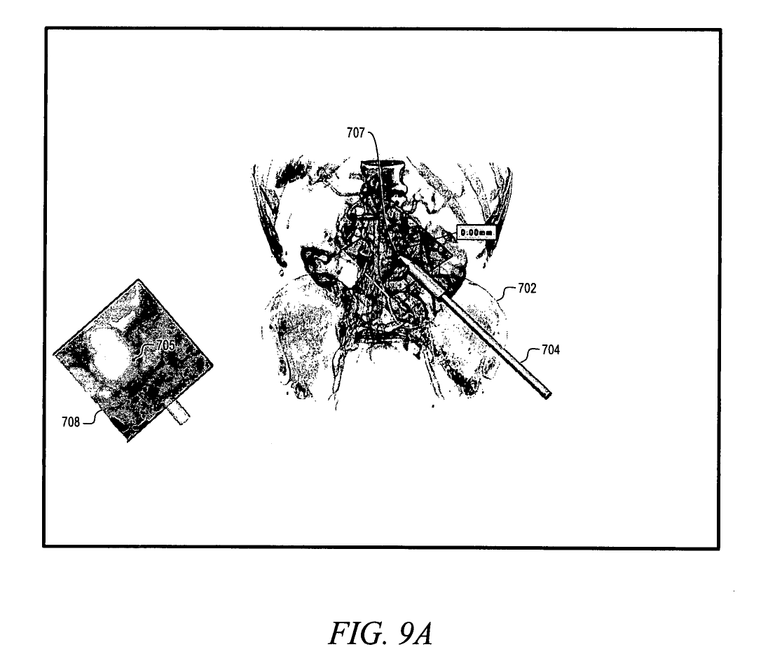

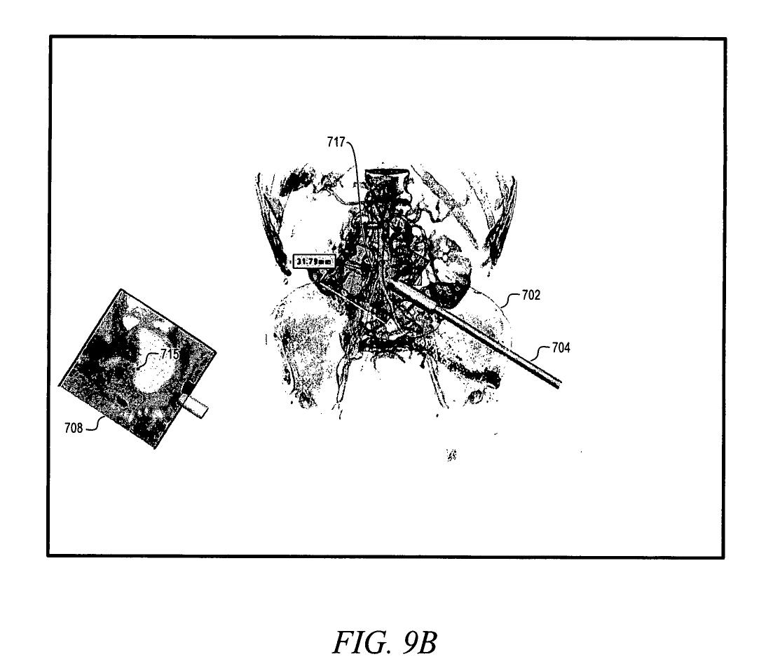

FIGS. 9A-9B illustrate a use of a slice viewer for marking and measuring in a volume, in accordance with one embodiment. In FIG. 9A, the position of the tip of the virtual tool is shown as a red dot 705 within the slice viewer 708, as the virtual tool 704 is moved within the volume 702 in the 3D view. The indication of the position of the tip of the virtual tool 704 in the slice viewer 708 allows a user to precisely position the tip of the virtual tool 704 at a desired location inside the volume 702. The desired location inside the volume 702, as identified by the tip of the virtual tool 704, can be selected for the placement of a marker 707. The placed marker 707 can be subsequently used to identify the selected location for various purposes, such as measurement, annotation, editing, etc. The slice viewer 708 shows details of the volume at the vicinity of the tip of the virtual tool and provides clear guidance to the navigation of the virtual tool in the volume. Thus, a user can precisely position the tip of the virtual tool at a desired location without having to change tools and/or crop and uncrop the volume. When the tip of the virtual tool is at the desired location, the user can activate a switch such as a button on the location-tracked stylus; and the system stores the location of the tip of the virtual tool as a point of interest (e.g., a measuring point, or a marker).

FIG. 9B illustrates that the tip of the virtual tool 704 is moved to another point 717 of interest within the volume 702. The tip of the virtual tool 704 can be moved to the desired location via the guidance of the slice displayed within the slice viewer and the red dot 715 that represents the current position of the tip of the virtual tool relative to the slice.

After points of interests are identified, a measurement between the points (e.g., 707 and 717) can be computed. For example, the distance between the points 707 and 717 can be computed based on their positions within the volume 702.

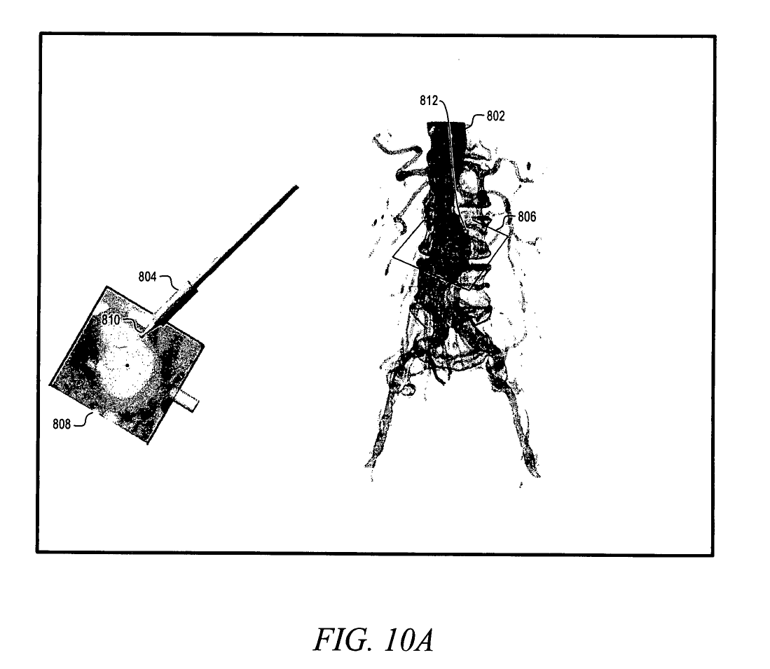

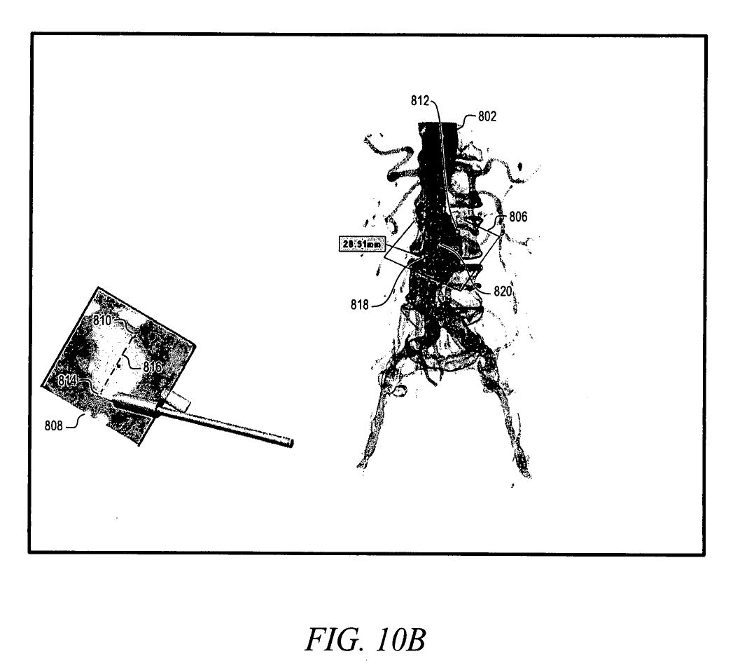

FIGS. 10A-10B illustrate another use of a slice viewer for marking and measuring in volume, in accordance with one embodiment. In FIGS. 10A-10B, after a virtual tool is used to select a slice 806 in the volume 802, the virtual tool 804 can be used to operate on the slice viewer 808 (e.g., after a user activation). For example, after the virtual tool used to select the slice is at a desired location in the volume 802, a button on the input interface (e.g., a location-tracked stylus) can be pressed to cause the system to store the desired location of the slice. The user can then control the input interface to move the virtual tool to the vicinity of the slice viewer 808, which causes the system to switch the virtual tool from the mode for selecting a slice in the volume to the mode for selecting a point on the slice viewer 808, which displays the recently select and stored slice.

In FIGS. 10A-10B, the virtual tool 804 does not control the positioning of the slice 806; thus, the slice 806 and the slice viewer 808 appear to be frozen (e.g., not updated in response to the input from the input interface that controls the virtual tool 804). The virtual tool 804 can be used to place markers 810 and 814 within the slice viewer 808. The system can compute the corresponding locations in the 3D volume 802 for the markers 812 and 818, based on the position of the markers 810 and 814 in the slice viewer 808 and the spatial mapping between the slice viewer 808 and the slice 806.

In one embodiment, as the markings 810 and 814 are placed in the slice viewer 808 using the virtual tool 804, the markings 812 and 818 are also shown in the corresponding positions within the volume 802. In FIG. 10B, the line segment 816 in the slice viewer 808 correspond to the line segment 820 in the slice 806.

Once the points in the volumes are identified, measurements can be made based on the locations of the points in the volume. For example, a distance between the markings 812 and 818 can be computed based on the line segment 820; and the distance measurement is displayed at a location close to the marker 818.

Multiple Slices

In one embodiment, the virtual tool can be used to identify a number of slices in a volume. The slices of the volume are sampled, stored and then displayed for review.

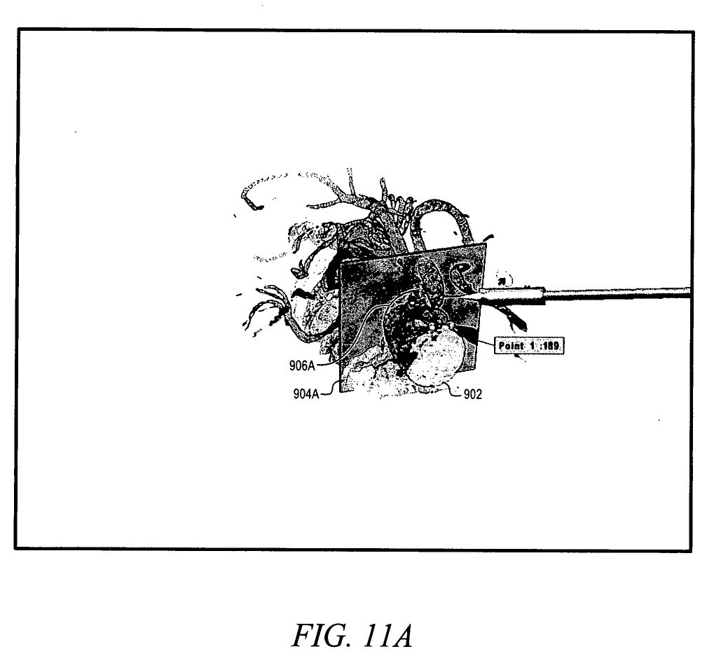

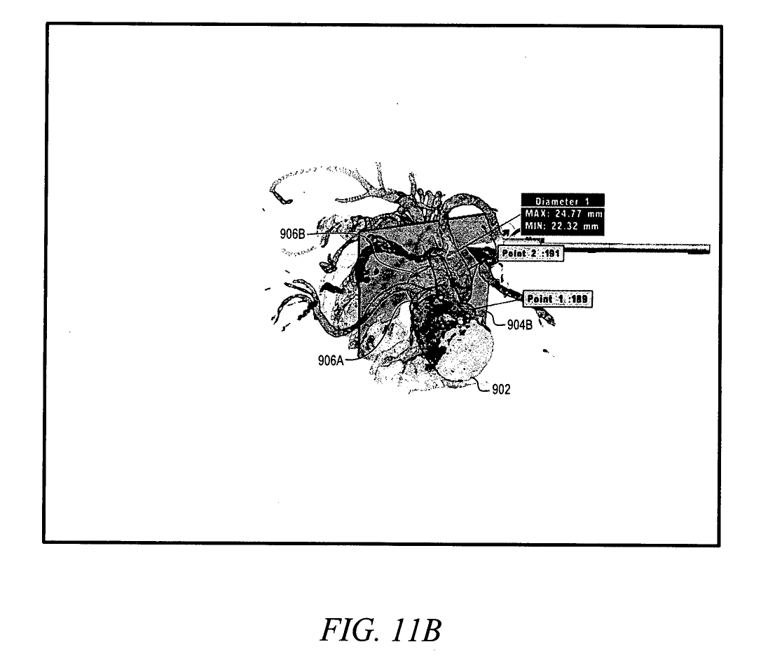

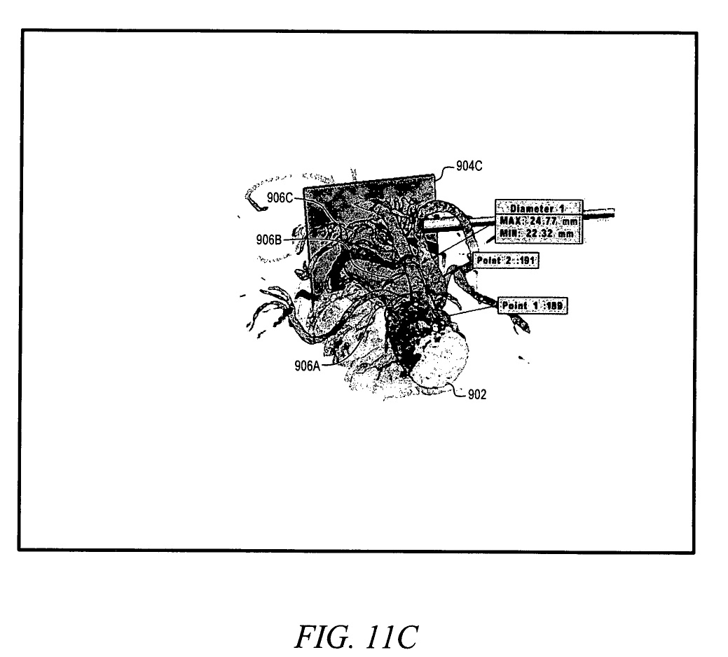

FIGS. 11A-11C illustrate a use of multiple slices within a volume, in accordance with one embodiment. For example, a first slice 904A is identified using a virtual tool as shown in FIG. 11A; a second slice 904B is identified using the virtual tool as shown in FIG. 11B; and a third slice 904C is identified using the virtual tool as shown in FIG. 11C.

In one embodiment, identifiers 906A, 906B and 906C are shown in the 3D view of the volume, after the slices 904A, 904B, and 904C are selected. The identifiers are used to indicate the location of the selected slices.

Preferably, the identifies 906A, 906B and 906C are generated along the intersection between the slice and the outer surface of the structure of the volume 902, as illustrated in FIGS. 11A-11C. Alternatively, identifiers can be frozen images of the selected slices at the selected locations. The frozen images may be partially transparent or opaque.

In FIGS. 11A-11C, the surface of the virtual tool used to select the slices 904A, 904B, and 904C are opaque. Alternatively, the surface of the virtual tool can be partially transparent.

After the slices are selected, a user can switch or toggle among the slices to display the slices one at a time. For example, in response to a user input, the system can display the sequence of slices in a slice viewer separate from the volume. The slice viewer has an orientation consistent with the selected slices but constrained within a plane parallel to the screen plane. In one embodiment, a position of the slice viewer can be specified by the user. For example, the user can drag the slice viewer to a desired location; and the system then displays the slices at the user specified location when the user switch or toggle among the slices (e.g., using a slider or an index). Alternatively, the slice viewer displays the slices with a fixed orientation, regardless the orientation of the slices.

The slice viewer can display each slice for a short period of time and then display the next slice without receiving a further user input. Alternatively, the slice viewer can step through the slices one at a time according to user input. Alternatively, a slider or an index can be displayed, which allows the user to randomly select a slice from the set of slices for display.

Obtaining and saving multiple slices can provide support for many applications. For example, automated abdominal aortic aneurysm measurements can be performed based on multiple identified slices.

For example, a tube-like organ of interest may be segmented out from original image slices. The centerline of the organ is calculated based on identifying the centers in a number of slices; and the centerline is then used to create a skeleton of the tube-like organ. Based on the centerline extracted, a pre-defined template structure is mapped to the tube-like organ. Since the required measurements are defined in the template, the measurements of the organ is then calculated for the organ based on the mapping between the template structure and the organ. The measurements can be further refined in a three dimensional environment and be used to form a structured clinical report for further use.

Further details on such applications based on multiple identified slices can be found in U.S. patent application Ser. No. 11/289,230, entitled Methods for Automated Abdominal Aortic Aneurysm Measurements and Visualization Using Knowledge Structure Mapping (“Knowledge Structure Mapping”) and filed on Nov. 28, 2005, the disclosure of which is incorporated herein by reference.

Segmentation and Localized Image Processing

In one embodiment, the virtual tool can be used to select slices that are used as a cutting tool to specify multiple boundary planes, which delineate a region of interest in the volume. A system can determine the region that is delineated by the specified slices to segment the region out of the volume. For example, when the slices as selected by the virtual tools are not connecting with each other to form a connected surface, the slices can be extended by the system to form a connected surface.

The region as selected by cuts indicated by the selected slices can be further processed for further precision segmentation. For example, segmentation algorithms, such as threshold, level-set, k-means clustering, wavelet propagations, region grow, etc., can be applied the region delineated by the specified slices to extract an object of interest.

In one embodiment, contours can be specified in a number of slices to form a contour surface through interpolation. The contour surface can be used to delineate a region for segmentation. The contours can be edited based on the display of the slices on a virtual panel, which is arranged at a location that is perceived to be on a solid surface (e.g., 216 of FIG. 2B). The support of the solid surface allows the user to perform precision curve editing with ease, using a stylus. Details on editing a curve in a virtual reality environment can be found in U.S. patent application Ser. No. 10/489,463, filed on Sep. 12, 2001, the disclosure of which is hereby incorporated herein by reference.

Furthermore, imaging processing can be applied to the slice to present an enhanced view of the selected slice; and the enhancement can be performed in real time as the virtual tool is moved in the 3D view to select different slices. A continuous, smooth transition of enhanced view of slices can be presented. Various localized image processing, such as histogram analysis, smoothing, noise removal, edge detection, edge sharpening, contrast enhancement, white balancing, etc., can be applied to the slice that is selected for enhanced visualization results.

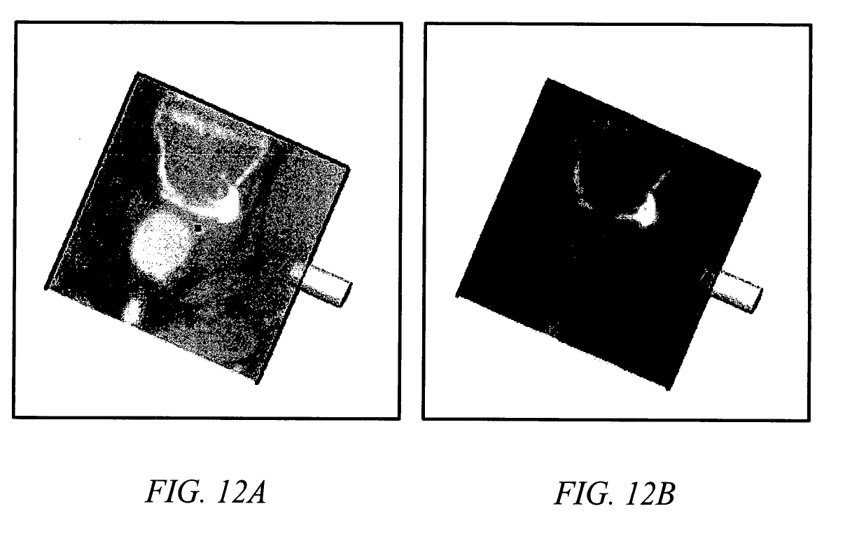

FIGS. 12A-12B illustrate localized image processing applied to a slice displayed in a slice viewer. FIG. 12A shows a slice viewer displaying a selected slice without filtering. FIG. 12B shows a slice viewer displaying the selected slice after applying an image histogram normalization to provide a contrast effect. The contrast enhanced display in FIG. 12B allows a user to identify the features shown in the slice viewer with ease.

### Variations

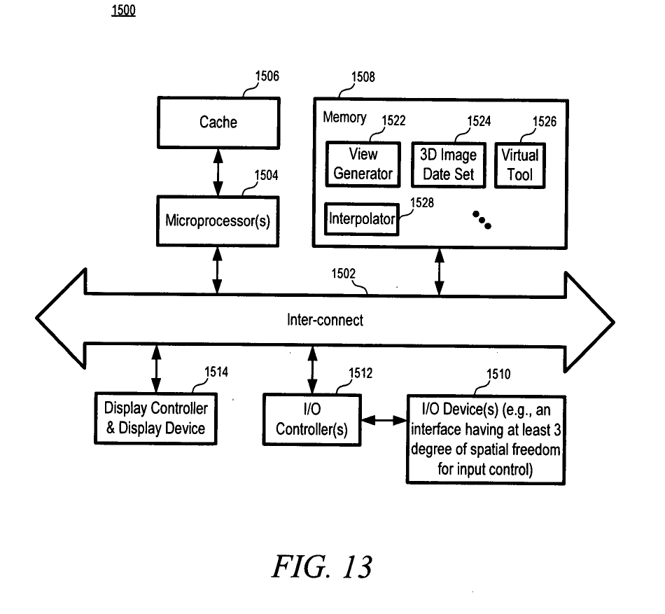

The processes described above can be stored in a memory of a computer system as a set of instructions to be executed. FIG. 13 shows a block diagram example of a data processing system for displaying 3D views according to one embodiment.

While FIG. 13 illustrates various components of a computer system, it is not intended to represent any particular architecture or manner of interconnecting the components. Other systems that have fewer or more components can also be used.

In FIG. 13, the computer system 1500 is a form of a data processing system. The system 1500 includes an inter-connect 1502 (e.g., bus and system core logic), which interconnects a microprocessor(s) 1504 and memory 1508. The microprocessor 1504 is coupled to cache memory 1506, which can be implemented on a same chip as the microprocessor 1504.

The inter-connect 1502 interconnects the microprocessor(s) 1504 and the memory 1508 together and also interconnects them to a display controller and display device 1514 and to peripheral devices such as input/output (I/O) devices 1510 through an input/output controller(s) 1512.

In one embodiment, the I/O devices 1510 include an interface having at least 3 degree of spatial freedom for input control, such as a location-tracked stylus 202a illustrated in FIGS. 2A and 2B. The location of the stylus can be tracked using a tracking system coupled to the I/O controller(s) 1512, such as a camera based tracking system, or a radio or other electromagnetic signal, or ultrasound, laser based tracking system, or any other tracking system now known or to become known. In one embodiment, a further handheld device 6D controller 202b having a shape of a joystick, as illustrated in FIG. 2A, couples with the I/O controller(s) 1512 for input control. The I/O devices further optionally include one or more of mice, keyboards, modems, network interfaces, printers, scanners, video cameras and other devices.

The inter-connect 1502 can include one or more buses connected to one another through various bridges, controllers and/or adapters. In one embodiment, the I/O controller 1512 includes a USB (Universal Serial Bus) adapter for controlling USB peripherals, and/or an IEEE-1394 bus adapter for controlling IEEE-1394 peripherals. In some embodiments, the inter-connect 1502 can include a network connection.

The memory 1508 can include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory can also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

The instructions to control the display of views according to various embodiments can be stored in memory 1508 or obtained through an I/O device (e.g., 1510). In one embodiment, the generated views of a 3D image data set is displayed using the display controller and display device 1514.

For example, the memory 1508 stores the 3D image data set 1524 and instruction modules for a virtual tool 1526, an interpolator 1528, a view generator 1522, and others. The virtual tool module 1526 generates the display of a virtual tool in a 3D view of the 3D image data set 1524 in a volume, according to input received from an I/O device, such as the location-tracked stylus. In one embodiment, the virtual tool is associated with a slice viewer. In one embodiment, the virtual tool is associated with a tunnel viewer. In one embodiment, the virtual tool can be switched between being associated with the slice viewer and being associated with the tunnel viewer. In one embodiment, the virtual tool can be associated with both the slice viewer and the tunnel viewer. The interpolator 1528 is used to sample the 3D image data set for a portion of the volume, such as a slice of the volume that is at the intersection between the volume and a surface of the virtual tool. The view generator 1522 includes instructions to generate the 3D view according to the various embodiments provided above.

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1. A method, comprising:
identifying a location of a volume, based on input communicated via an input interface having at least 3 degrees of spatial freedom for input control; and
displaying the volume and separately displaying a portion of the volume corresponding to the location.

2. The method of claim 1, further comprising:
displaying a virtual tool having a surface, the portion of the volume being identified at an intersection between the volume and the surface of the virtual tool.

3. The method of claim 1, wherein the portion of the volume comprises a planar slice of the volume.

4. The method of claim 1, further comprising:
projecting the volume onto a screen plane, wherein said displaying the volume is based on said projecting; and
wherein said separately displaying the portion of the volume further comprises displaying the portion of the volume in an orientation parallel to the screen plane.

5. The method of claim 4, wherein the portion of the volume is displayed within the screen plane.

6. The method of claim 4, wherein when a projection of the identified location in the volume on the screen plane is rotated in the screen plane, the orientation used to separately display the portion of the volume is also rotated in the screen plane.

7. The method of claim 4, wherein said projecting the volume comprises projecting the volume for a stereoscopic display of the volume.

8. The method of claim 3, wherein the input interface includes a hand held device; and said displaying the volume further comprises displaying a virtual tool according to a location of the hand held device.

9. The method of claim 8, wherein the virtual tool comprises a partially transparent surface.

10. The method of claim 9, wherein the separately displayed portion of the volume corresponds to an intersection between the partially transparent surface and the volume.

11. The method of claim 10, wherein the identified location within the volume is oblique within the volume.

12. The method of claim 10, wherein said separately displaying the portion of the volume comprises displaying the portion of the volume within a window having a pre-determined size.

13. The method of claim 12, wherein an orientation of the window is related to an orientation of the partially transparent surface.

14. The method of claim 13, further comprising in response to a user input, adjusting a size of the partially transparent surface, to produce a variation of a zoom factor in the separate display of the portion of the volume.

15. The method of claim 13, further comprising in response to a user input, adjusting a display size of the volume relative to the partially transparent surface, to produce a variation of a zoom factor in the separate display of the portion of the volume.

16. The method of claim 3, wherein said displaying the volume further comprises displaying the volume in a 3D view; and said separately displaying the portion of the volume further comprises displaying the slice in the 3D view on a plane that appears to be on a solid surface of a user interface system.

17. The method of claim 3, further comprising placing a first marker within the volume, based on a position within the volume selected with the virtual tool.

18. The method of claim 17, further comprising, in response to placing a second marker within the volume, generating a measurement based on positions of the first marker and second marker in the volume.

19. The method of claim 18, further comprising displaying the measurement at a corresponding location within the volume.

20. The method of claim 3, further comprising determining a position of the first marker in the volume, based on a position selected within the separately displayed portion of the volume, the position within the separately displayed portion selected via the virtual tool.

21. The method of claim 3, further comprising generating a segmentation of the volume based on one or more portions of the of the volume.

22. The method of claim 3, further comprising, alternately displaying one of the multiple portions of the volume, based on user selection.

23. The method of claim 3, wherein said separately displaying the portion of the volume comprises interpolating the identified location of the volume to obtain image data for the portion of the volume.

24. The method of claim 3, wherein said separately displaying the portion of the volume further comprises image filtering of the image data for the portion of the volume.

25. A system, comprising:
means for identifying a location of a volume based on input communicated via an input interface having at least 3 degrees of spatial freedom for input control; and
means for displaying the volume and separately displaying a portion of the volume corresponding to the location.

26. A machine-readable medium having stored thereon a set of instructions which when executed cause a machine to perform a method comprising:
identifying a location of a volume based on input communicated via an input interface having at least 3 degrees of spatial freedom for input control; and
displaying the volume and separately displaying a portion of the volume corresponding to the location.

27. A system, comprising:
memory to store instructions; and
one or more processors coupled to the memory, responsive to the instructions stored in the memory the one or more processors to identify a location of a volume based on input communicated via an input interface having at least 3 degrees of spatial freedom for input control and to display the volume and separately display a portion of the volume corresponding to the location.

28. The system of claim 27, further comprising:
the input interface coupled to the one or more processors.

29. The system of claim 28, wherein the input interface comprises a tracker coupled to the one or more processors and a stylus tracked by the tracker.

30. The system of claim 28, further comprising:
a display device coupled to the one or more processors to provide a stereoscopic display of the volume and the portion of the volume separate from the volume.

31. The system of claim 27, wherein the one or more processors are to further display a virtual tool having a surface; the portion of the volume is identified at an intersection between the volume and the surface of the virtual tool; the surface of the virtual tool is to have one or more markers; and the portion of the volume displayed separately from the volume is to have one or more markers corresponding to the one or more markers of the surface of the virtual tool.

32. The system of claim 31, wherein the one or more markers of the virtual tool comprise different colored edges; and the portion of the volume displayed separately from the volume is to have different colored edges corresponding to the colored edges of the surface of the virtual tool.

33. The system of claim 31, wherein the one or more markers of the virtual tool comprise a handle; and the portion of the volume displayed separately from the volume is to have a representation corresponding to the handle of the virtual tool.
